(19) United States
(12) Patent Application Publication
(10) Pub. No.: US 2014/0083908 A1
(43) Pub. Date: Mar. 27, 2014

(54) CONTINUOUS CATALYST REGENERATION REACTOR WITH DEFLECTOR MEANS FOR DEFLECTING THE FLOW OF CATALYST IN THE OXYCHLORINATION ZONE

(71) Applicant: IFP ENERGIES NOUVELLES, RUEIL-MALMAISON CEDEX (FR)

(72) Inventors: Cecile PLAIS, Les Haies (FR); Frederic BAZER-BACHI, Irigny (FR); Eric SANCHEZ, Saint Genis Laval (FR); Thierry LEFLOUR, Paris (FR)

(73) Assignee: IFP ENERGIES NOUVELLES, RUEIL-MALMAISON CEDEX (FR)

(21) Appl. No.: 14/036,116

(22) Filed: Sep. 25, 2013

(30) Foreign Application Priority Data
Sep. 27, 2012 (FR) 12/02.571

(51) Int. Cl. B01J 8/00

(52) U.S. Cl. CPC B01J 8/008
USPC 208/134; 422/619; 29/890

(57) ABSTRACT

The reactor 1 for continuously regenerating grains of catalyst is composed of a vessel 2 containing an oxychlorination zone 72 positioned above a calcining zone 75 provided with a line for introducing calcining gas 76, the reactor containing an oxychlorination gas injection line 73 opening into the bottom of the oxychlorination zone 72 and a gas evacuation line 74b at the head of the oxychlorination zone, characterized in that the oxychlorination zone 72 contains at least one deflector means 82 for deflecting the flow of grains of catalyst.

The present invention relates to the field of hydrocarbon conversion, and more specifically to reforming hydrocarbon feeds in the presence of a catalyst in moving bed mode in order to produce gasoline cuts. The present invention proposes a catalyst regeneration reactor with an oxychlorination zone provided with deflector means for deflecting grains of catalyst in order to improve contact of the oxychlorination gas with the catalyst.

Processes for the catalytic reforming of gasolines functioning in moving bed mode generally employ a reaction zone which can comprise three or four reactors in series and a catalyst regeneration zone which implements a certain number of steps, in general a combustion step, then an oxychlorination step, followed by a calcining step and a reduction step. The document U.S. Pat. No. 3,761,390 describes an example of carrying out a catalytic reforming process functioning in moving bed mode.

The document U.S. Pat. No. 7,985,381 describes, in detail, a regeneration reactor comprising a combustion zone, an oxychlorination zone and a calcining zone. The catalyst moves in the reactor in a vertical downwards direction. It passes from the oxychlorination zone to the calcining zone via an annular ring. A calcining gas injected into the bottom of the calcining zone passes through the bed of catalyst in the calcining zone as a counter-current and then is recovered in a second annular zone located at the periphery of the reactor. In that second annular zone, the oxychlorination gas is injected in order to be mixed with the calcining gas which has been recovered. The gas mixture is then injected at the periphery of the reactor into the bottom of the oxychlorination zone.

The disadvantage of injecting this mixture of gas at the periphery of the reactor is that it generates a gas velocity profile which is not homogeneous at the outlet from the injection zone over the section of the oxychlorination zone. In addition, the passage for the catalyst from the oxychlorination zone to the calcining zone via an annular ring in the reactor is bulky and generates pressure drops. However, the pressure drops are not sufficient to prevent the calcining gas from rising directly via the catalyst droplegs without passing into the outer annular ring and thus without being mixed with the oxychlorination gas.

The present invention proposes optimizing the gas mixture in the oxychlorination zone by providing deflector means for deflecting the flow of grains of catalyst in the oxychlorination zone in order to favour mixing and dispersion of the mixture of gas and to improve the contact of the catalyst grains with the oxychlorination gas.

In general, the present invention concerns a reactor for the continuous regeneration of grains of catalyst, composed of a vessel comprising a first zone positioned above a second zone provided with a line for introducing a first gas. The reactor comprises a line for injecting a second gas opening into the bottom of the first zone and a gas evacuation line at the head of the first zone. The reactor is characterized in that the first zone comprises at least one deflector means for deflecting the flow of grains of catalyst.

More precisely, the present invention may concern a reactor for the continuous regeneration of grains of catalyst, composed of a vessel comprising an oxychlorination zone positioned above a calcining zone provided with a line for introducing calcining gas. In this case, the reactor comprises a line for injecting oxychlorination gas opening into the bottom of the oxychlorination zone and a gas evacuation line at the head of the oxychlorination zone. This reactor is characterized in that the oxychlorination zone comprises at least one deflector means for deflecting the flow of grains of catalyst.

In accordance with the invention, the deflector means may be composed of a plate which is impervious to catalyst grains and impervious to gas. Alternatively, the deflector means may be composed of a plate which is impervious to grains of catalyst and permeable to gas.

The deflector means may be separated by a height of at least 10 cm with respect to the position at which the oxychlorination gas injection line opens into the oxychlorination zone.

The surface of the deflector means projected onto a horizontal surface may be in the range 1% to 20% of the horizontal section of the oxychlorination zone.

The deflector means may have a shape selected from: a planar portion, a channel the bottom of which is orientated upwardly, or a hemispherical portion.

The oxychlorination zone may comprise at least two deflector means for deflecting the flow of grains of catalyst and the two deflector means may be disposed at the same height.

The oxychlorination zone may comprise at least two deflector means for deflecting the flow of grains of catalyst and the two deflector means may be disposed at two different heights.

The two deflector means may be in the form of channels extending in two different directions.

The injection line may be connected to a gas distribution means in order to distribute the oxychlorination gas over the section of the oxychlorination zone.

The distribution means may be composed of a plurality of tubes comprising orifices, a hood covering each of the tubes in order to prevent the grains of catalyst from coming into contact with said tubes.

The wall of the reactor may comprise means for reducing the horizontal section of the oxychlorination zone.

The reactor of the invention may be employed in a process for catalytic reforming of a hydrocarbon feed, in which:
a stream of grains of catalyst is introduced at the head of the oxychlorination zone;
a stream of calcining gas is introduced via the calcining gas introduction line;
a stream of oxychlorination gas is introduced via the oxychlorination gas injection line;
a stream of gas is evacuated from the head of the oxychlorination zone;
a stream of grains of catalyst is evacuated from the bottom of the calcining zone.

The grains of catalyst may comprise platinum deposited on a porous support, the stream of calcining gas may comprise air or oxygen-depleted air and may be at a temperature in the range 400° C. to 550° C., the stream of oxychlorination gas may comprise a chlorinated compound and may be at a temperature in the range 350° C. to 550° C.

In accordance with the invention, an existing reactor may be remodelled by inserting said deflector means into the oxychlorination zone.

Other characteristics and advantages of the invention will be better understood and will become apparent from the following description made with reference to the drawings, in which:

### BRIEF DESCRIPTION OF THE DRAWINGS

FIG. 1 represents a catalyst regeneration reactor;

FIG. 2 represents an embodiment of the oxychlorination zone in accordance with the invention;

FIG. 3 represents a second embodiment of the oxychlorination zone of the invention;

FIGS. 4A, 4B, 4C and 4D represent different embodiments of deflector means for deflecting the flow of grains of catalyst;

FIG. 5 represents a third embodiment of the oxychlorination zone of the invention.

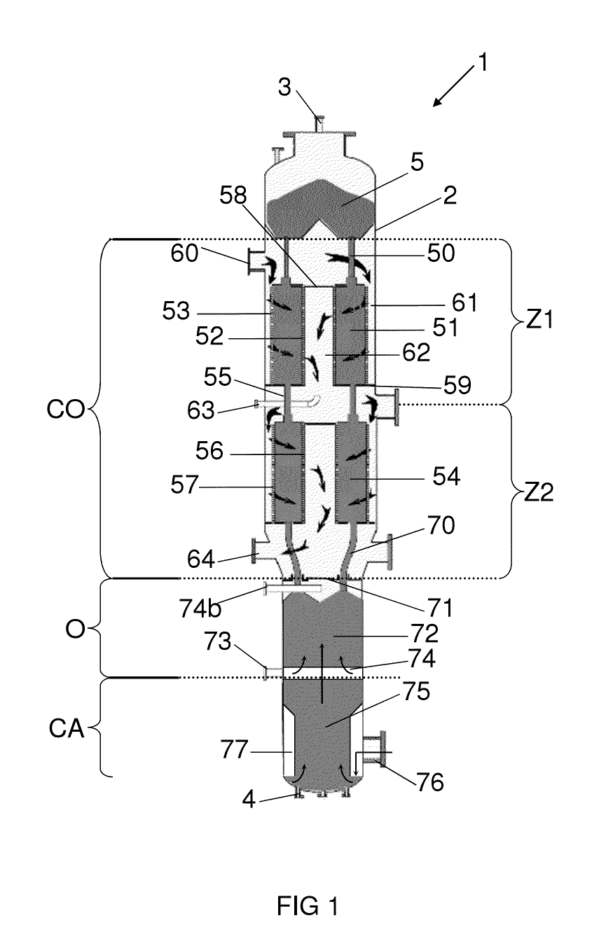

In FIG. 1, the catalyst regeneration reactor is composed of a vessel 2 containing a combustion zone CO, an oxychlorination zone O and a calcining zone CA. The vessel 2 may be in the form of a cylinder with a vertical axis, the cylinder being closed at its ends. The combustion, oxychlorination and calcining zones are positioned one above the other in the reactor 1. In the reactor 1, these zones may be of the same diameter or have different diameters.

The catalyst to be regenerated is introduced at the head of the reactor 1 via a line or lines 3 and is evacuated from the reactor 1 via lines 4 located at the bottom of the reactor 1. The catalyst moves from top to bottom in the reactor under gravity, passing in succession through the combustion zone CO, oxychlorination zone O and calcining zone CA. The catalyst is evacuated from the reactor 1 at the bottom of the calcining zone CA via the lines 4. The reactor 1 is continuously supplied with catalyst and the catalyst moves continuously in the reactor 1.

The catalyst is in the form of solid grains, for example in the form of beads 0.5 to 20 mm in diameter, in order to facilitate movement of the catalyst in the reactor 1. The grains of catalyst are composed of a porous support, for example an alumina, on which various compounds are deposited, in particular platinum and chlorine, and optionally tin, rhenium, indium and/or phosphorus. The catalyst to be regenerated comprises coke, for example approximately 5% by weight of coke.

The catalyst introduced into the reactor 1 via the line 3 arrives in a reservoir 5 provided with a hopper in order to supply the combustion zone CO with catalyst.

The combustion zone CO is intended to carry out the combustion of coke deposited on the catalyst. The zone CO may comprise one or more stages. The reactor 1 of FIG. 1 comprises two stages Z1 and Z2. In accordance with a particular embodiment, the combustion zone may also comprise a combustion control zone, for example such as that described in document FR 2 761 907. The catalyst of the reservoir 5 is introduced into an annular space 51 of the stage Z1 via supply lines 50. The annular space 51 is defined by two tubular screens 52 and 53, for example cylindrical and concentric. The space 61 located between the tubular screen 53 and the vessel 2 is closed off at its lower end by the plate 59. The space 61 may be arranged in the shape of a portion which is routinely known as a scallop section. The central space 62 located inside the tubular screen 52 is closed off at its upper end by the plate 58. The catalyst from the annular space 51 is introduced into an annular space 54 of the stage Z2 via supply lines 55. The space 54 is defined by two tubular screens 56 and 57, for example cylindrical and concentric. The screens 52, 53, 56 and 57 can be used to retain the catalyst while allowing gas to pass through. As an example, the screens 52, 53, 56 and 57 may be Johnson screens and/or perforated plates.

A first combustion gas stream containing oxygen is introduced into the vessel 2 at the head of the stage Z1 via the orifice 60. In the stage Z1, the gas stream moves in the direction of the arrows indicated in FIG. 1, passing through the bed of catalyst contained in the annular space 51. In fact, the impervious plates 58 and 59 force the combustion gas supplied via the orifice 60 to pass from the space 61 at the periphery of the annular space 51 to the central space 62 located inside the screen 52, passing through the catalyst in the annular space 51. In the space 51, the oxygen contained in the combustion gas can be used to generate the combustion of coke deposited on the catalyst. A second stream of combustion gas containing oxygen is introduced between the stage Z1 and Z2 via the line 63. This second stream mixes with the first flow of gas that has passed through stage Z1. In the same manner as for the stage Z2, the combustion gas passes through the bed of catalyst contained in the annular space 54 in the direction of the arrows indicated in FIG. 1. After having passed through the catalyst of the zone 54, the combustion gas is evacuated from the stage Z2 via the line 64.

In accordance with another embodiment, the combustion zone CO may be arranged such that the combustion gas moves from the inside to the outside in the annular spaces 51 and 54. In addition, alternatively, in accordance with another embodiment, the combustion zone may be arranged such that the gas flow is injected at the bottom of the zone CO and evacuated from the head of the zone CO.

The catalyst in the annular zone 54 of the combustion zone flows from the combustion zone CO into the oxychlorination zone O via the lines 70. The plate 71 disposed between the combustion zone and the oxychlorination zone O is gas-tight in order to prevent gas from moving between these two zones.

In particular, the oxychlorination zone O is aimed at recharging the grains of catalyst with chlorine and at re-dispersing platinum at its surface in order to improve the distribution of platinum in the grains of catalyst. In the oxychlorination zone O, the catalyst flows in the internal space 72 of the reactor, for example the cylindrical space defined by the walls of the vessel 2 of the reactor. In accordance with the invention, an oxychlorination gas is injected into the bottom of the oxychlorination zone. As an example, the bottom of the space 72 of the oxychlorination zone O is provided with a line 73 which can be used to inject oxychlorination gas into the oxychlorination zone. The oxychlorination gas comprises a chlorine-containing compound and may be at a temperature in the range 350° C. to 550° C., preferably in the range 460° C. to 530° C. The oxychlorination gas injection line 73 can communicate with a gas distribution means 74 which can be used to distribute the stream of oxychlorination gas over at least a portion of the horizontal section of the oxychlorination zone O. As an example, the gas distribution means 74 may be composed of tubes provided with orifices. At the head of the space 72, the line 74b can be used to evacuate gas from the oxychlorination zone O. The oxychlorination gas injected via the line 73 moves in an upwards direction through the space 72, as a counter-current to the gravitational flow of the catalyst. When the oxychlorination gas comes into contact with the catalyst, the chlorine of the gas is deposited on the grains of catalyst. Next, the gas which has passed through the space 72 is evacuated from the vessel 2 via the line 74b.

The catalyst arriving at the bottom of the oxychlorination zone O continues to flow from the space 72 to the space 75 of the calcining zone CA. The particular aim of the calcining zone is to dry the catalyst grains. The bottom of the calcining zone CA is provided with a line 76 which can be used to inject calcining gas at the bottom of the space 75. The calcining gas comprises air or air which is depleted in oxygen and may be at a temperature in the range 400° C. to 550° C. In order to distribute the calcining gas in a homogeneous manner in the space 75, the line 76 may open into an annular space 77 disposed at the periphery between the space 75 and the vessel 2. The annular space 77 is open at its lower portion located at the bottom of the space 75 of the calcining zone CA. Thus, the gas injected via the line 76 is distributed in the bed of catalyst over the whole of the periphery at the bottom of the space 75. The calcining gas injected via the line 76 moves in an upwards direction, as a counter-current to the gravitational flow of catalyst through the space 75, then through the space 72. When the calcining gas passes from the space 75 to the space 72, it encounters and mixes with oxychlorination gas injected via the line 73. Next, the gas which has passed through the space 72 is evacuated from the vessel 2 via the line 74b.

In accordance with the invention, one or more deflector means are disposed in the space 72 of the oxychlorination zone in order to deflect the flow of catalyst grains moving in the space 72.

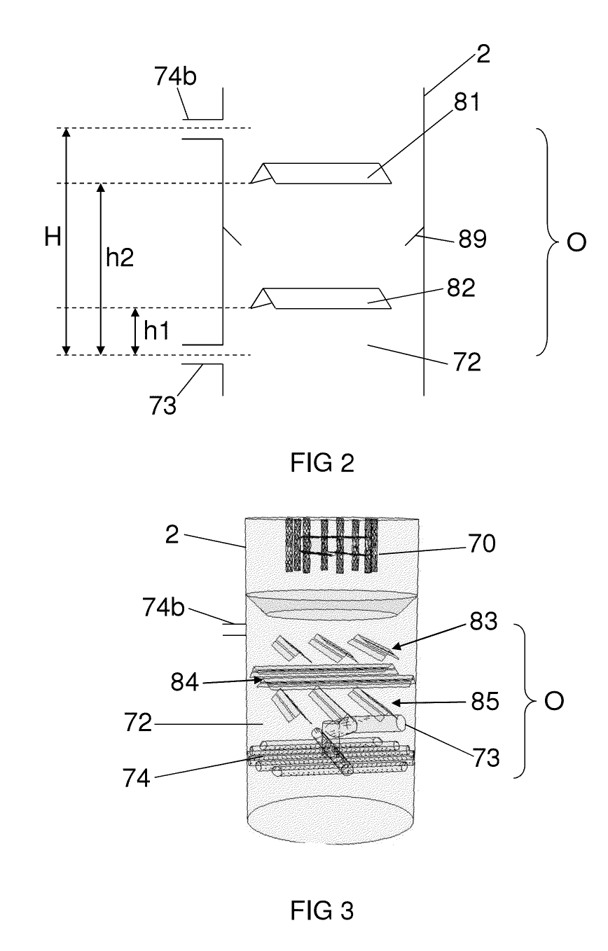

Various embodiments of the space 72 of the oxychlorination zone O are described with reference to FIGS. 2, 3 and 5. The references in FIGS. 2, 3 and 5 which are identical to those of FIG. 1 designate the same elements.

Referring to FIG. 2, at least one means 82 are provided to deflect the flow of catalyst grains in the space 72 of the oxychlorination zone O. The means 82, also termed a deflector means, may be constituted by a portion of a plate which acts as a deflector in order to deflect the flow of catalyst grains. The means 82 for deflecting the flow of catalyst grains can be used to initiate a radial movement of grains of catalyst, and thus an intermingling, in addition to their vertical gravitational movement. Thus, the lateral movement of grains of catalyst has the advantage of promoting contact of the grains of catalyst with the stream of oxychlorination gas. In addition, a pocket of gas is created under the means 82 which is free from grains of catalyst. These pockets of gas are formed beneath the deflector which acts as a natural barricade. They create priority passages which perturb the upward flow of the mixture of oxychlorination and calcining gas and thus promote mixing and dispersion of the gas mixture over the entire horizontal section of the oxychlorination zone.

The deflector means may be composed of a portion of plate, for example metallic, which can be used to deflect the flow of grains of catalyst. In accordance with one embodiment, the deflector means is composed of a plate which is impervious to grains of catalyst and impervious to gas. In this case, the plate may be solid and continuous, without orifices. In accordance with this first embodiment, the grains of catalysts and the gas move around the deflector means. In accordance with another embodiment, the deflector means is composed of a plate which is impervious to grains of catalyst and permeable to gas. In this case, the plate comprises orifices which allow the gas to pass through, but not the grains of catalyst. As an example, a perforated plate or a Johnson screen may be used. In accordance with this second embodiment, the grains of catalysts move around the deflector means while the gas passes through the deflector means, providing for mixing of gas over the whole volume of the pocket located below the deflector means.

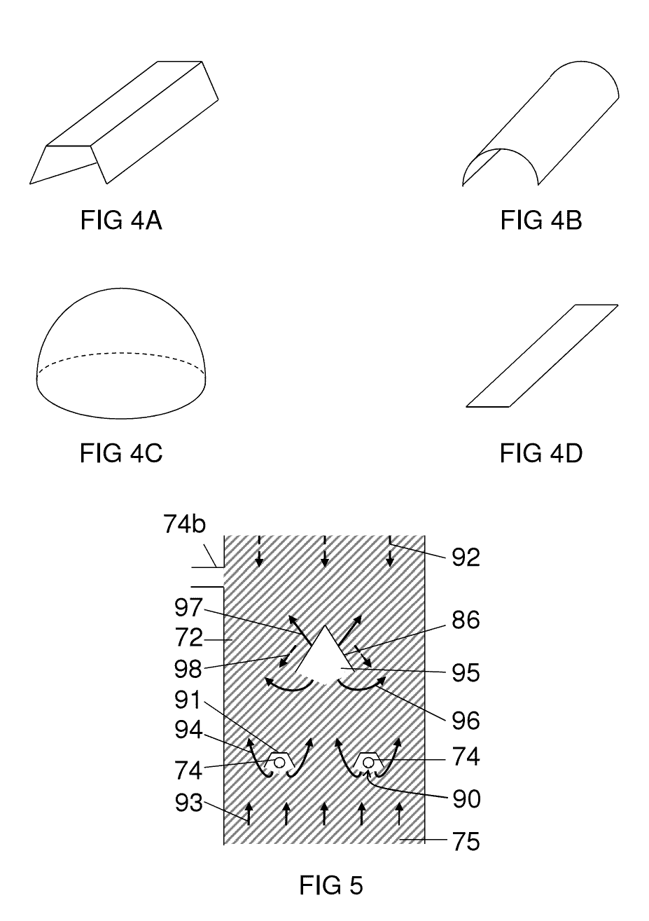

As an example, the deflector means may have the shape of a channel the bottom of which is upwardly orientated. The section of the channel may be a V shape as shown in FIG. 2. Alternatively, the deflector means may be in the shape of a channel the bottom of which is upwardly orientated and which has a section which may be U-shaped, as shown in FIG. 4A, or in the shape of an arc of a circle as shown in FIG. 4B. Preferably, the direction of the channel of a deflector means extends in a horizontal direction. Alternatively, the deflector means may have a hemispherical shape with its peak orientated towards the top, as shown in FIG. 4C. More simply, the means 82 may be in the shape of a portion of a flat plate, the plate being disposed in a horizontal plane or in a plane which is inclined with respect to the horizontal, for example inclined at an angle in the range 1° to 60°, preferably in the range 1° to 30°.

Preferably, the deflector means installed in the space 72 covers a minimal surface, in order to carry out the role of deflecting the grains of catalyst. However, in order to avoid going against the gravitational flow of the catalyst grains, the deflector means preferably does not exceed a maximum surface area. As an example, the surface area of a deflector means projected onto the horizontal surface is in the range 1% to 20%, preferably in the range 1% to 10% of the horizontal section of the oxychlorination zone 72.

The deflector means 82 is disposed in the space 72 between the position of the injection line 73 and the evacuation line 74b. Preferably, in order to initiate a lateral movement of the catalyst grains or to create a pocket of gas surrounded by grains of catalyst, the means 82 are located at a minimum distance from the injection line 73 in order to separate the means 82 from the line 73 by a layer of grains of catalyst. As an example, the means 82 is located at a height h1 from the line 73 of at least 10 cm, preferably at least 20 cm. The height h1 measures, in a vertical direction, the distance between the position at which the line 73 opens into the space 72 (or the position at which the orifices of the distribution means 74 open into the space 72, when a means 74 is present) and the lowest portion of the means 82. Preferably, the means 82 is located at a height h1 in the range 10% to 80% from H, preferably in the range 20% to 80% from H starting from the orifice of the line 73, H corresponding to the height measured over a vertical direction between the position at which the line 73 opens and the position of the line 74b.

In accordance with the invention, a means 89 may be added in order to reorientate the streams moving at the wall of the vessel 2 of the oxychlorination zone O. As an example, the means 89 may have a tapered shape or may be a bead disposed at the wall of the vessel 2 in order to reduce the horizontal section of the oxychlorination zone. These means 89 can be used to improve the contact of the grains of catalyst moving at the wall with the oxychlorination gas.

For legibility reasons, FIG. 2 shows a deflector means 82 disposed at height h1. However, the scope of the present invention encompasses disposing a plurality of deflector means at the same height h1, these deflectors having characteristics complying with the features mentioned above for the deflector means 82.

In order to improve mixing of the gas and catalyst grains, it is possible to use a plurality of means to deflect the grains of catalyst by disposing them at different heights in the oxychlorination zone O. Referring to FIG. 2, a second means 81 is disposed in order to deflect the flow of grains of catalyst in the space 72 of the oxychlorination zone O. The means 82 are located at a height h2 measured from the position at which the line 73 opens into the space 72 (or the position where the orifices of the distribution means 74 open into the space 72 when a means 74 is present). Preferably, the height h2 complies with the same criteria as the height h1. In addition, preferably, the means 81 is disposed at a different height from that of the means 82 in order to improve mixing of the grains of catalyst and mixing of gas. As an example, the means 82 are separated by a height of at least 10 cm, preferably at least 20 cm from the means 81; in other words, h2−h1>10 cm; preferably, h2−h1>20 cm.

FIG. 3 represents an embodiment of the invention in which three series 83, 84 and 85 of means are disposed so as to deflect the flow of grains of catalyst. Each of the series is composed of a plurality of deflector means disposed in a horizontal plane, i.e. the directions of the channels are included in the same horizontal plane. In FIG. 3, each series comprises three means in order to deflect grains of catalyst. Each of the series 83, 84 and 85 is disposed at a different height. Preferably, the deflector means are composed of channels, the direction of the channels being the same for the various deflectors of a series. In contrast, the direction of the channels between the deflectors of two different or contiguous series differs. As an example, the channels of series 83 and 85 extend in parallel directions and in contrast the channels of series 83 and 84 extend in different directions. As an example, the channels of series 83 extend in a direction which forms an angle in the range 0° to 90°, preferably in the range 30° to 90° with the direction of the channels of series 84. Referring to FIG. 3, the line 73 cooperates with a gas distribution means 74 composed of a plurality of tubes arranged as a rack. The tubes of the rack 74 are provided with orifices, preferably directed downwards in order to distribute the oxychlorination gas.

With reference to FIG. 5, the space 72 of the oxychlorination zone is provided with a means 86 for deflecting the flow of grains of catalyst. The tubes of the distribution means 74 are provided with orifices 90. Preferably, the orifices 90 are formed on the lower portion of the tubes. Each tube of the distribution means 74 is covered by a hood 91 the lower portion of which is open. The hoods 91 can be used to distribute the gas over a wider surface than the orifice 90. The hoods 91 are preferably disposed close to the tubes in order to prevent grains of catalyst from coming into contact with the tubes 74, while leaving a space between the tubes 74 and the hoods 91.

The operation of the oxychlorination zone of the invention is described with reference to FIG. 5. In FIG. 5, the space occupied by the catalyst is represented by hatching. The grains of catalyst flow from the combustion space into the space 72 then into the space 75 in the direction of the vertical downward arrows 92. The calcining gas moves in the space 75 and penetrates into the space 72 as shown by the arrows 93. The oxychlorination gas is injected via the distribution means 74. The oxychlorination gas is partially mixed with calcining gas, in particular by means of injection via the means 74. The calcining gas and the oxychlorination gas preferably flow to a pocket of gas 95 located below a deflector means 86 in the direction of flow shown by the arrows 94. If the deflector means 86 is impervious to gas, the gas mixture continues to rise, moving around the means 86 in accordance with the arrows 96. In contrast, if the deflector means 86 are permeable to gas, the mixture of gas continues to rise through the means 86 as shown by the arrows 97. The grains of catalyst, flowing downwards under gravity, are deflected around the deflector means 86 in the direction of flow shown by the arrows 98. Thus, the deflector means 86 can be used to generate a radial displacement of the grains of catalyst and to perturb the upward flow of the gas in the space 72 of the oxychlorination zone O in order to improve radial gas mixing and to promote contact of the grains of catalyst with the chlorine.

The simplicity of the deflector means and their low bulk means that these deflector means can be used in the context of remodelling, commonly called “revamping”, of a facility. In fact, it is possible to install the deflector means in an oxychlorination zone in an existing reactor using means for fixing them to the walls of the vessel or to other internal elements which are initially present. In addition, the loss of volume of the catalyst due to installation of the deflector means in an oxychlorination zone is small: the volume of material of the deflector means is marginal, the only real loss of catalyst volume consisting of the pockets of gas which are created below the deflector means.

The scope of the present invention also encompasses using the regeneration reactor of the invention in another type of unit employing moving bed technology and necessitating mixing of two gases moving as a counter-current in a moving bed of catalyst. As an example, the reactor of the invention may be employed in a skeletal isomerization unit, in a metathesis unit or in certain oligocracking or dehydrogenation units. In these cases, in general, the regeneration reactor comprises two zones: a first zone positioned above a second zone. The second zone is provided with a line for introducing a first gas. The reactor comprises a line for injecting a second gas opening at the bottom of the first zone and a line for the evacuation of gas at the head of the first zone. In accordance with the invention, the first zone comprises at least one deflector means for deflecting the flow of catalyst grains.

The entire disclosures of all applications, patents and publications, cited herein and of corresponding French Application No. 12/02.571, filed Sep. 27, 2012, are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. A reactor (1) for the continuous regeneration of grains of catalyst, containing a vessel (2) comprising a first zone (72) positioned above a second zone (75) provided with a line (76) for introducing a first gas, the reactor comprising a line (73) for injecting a second gas opening into the bottom of the first zone (72) and a gas evacuation line (74b) at the head of the first zone, characterized in that the first zone (72) comprises at least one deflector (82) for deflecting the flow of grains of catalyst.

2. A reactor according to claim 1, characterized in that the first zone is composed of an oxychlorination zone, the second zone is composed of a calcining zone, the first gas is composed of a calcining gas, and the second gas is composed of an oxychlorination gas.

3. A reactor according to claim 2, characterized in that the deflector (82) is composed of a plate which is impervious to grains of catalyst and impervious to gas.

4. A reactor according to claim 2, characterized in that the deflector (82) is composed of a plate which is impervious to grains of catalyst and permeable to gas.

5. A reactor according to claim 2, characterized in that the deflector (82) is separated by a height of at least 10 cm with respect to the position at which the oxychlorination gas injection line (73) opens into the oxychlorination zone.

6. A reactor according to claim 2, characterized in that the surface of the deflector (82) projected onto a horizontal surface is in the range 1% to 20% of the horizontal section of the oxychlorination zone.

7. A reactor according to claim 2, characterized in that the deflector (82) has a shape selected from: a planar portion, a channel the bottom of which is orientated upwardly, or a hemispherical portion.

8. A reactor according to claim 2, characterized in that the oxychlorination zone (72) comprises at least two deflectors (82) for deflecting the flow of grains of catalyst and in that the two deflectors are disposed at the same height.

9. A reactor according to claim 2, characterized in that the oxychlorination zone comprises at least two deflectors (81; 82) for deflecting the flow of grains of catalyst and in that the two deflectors are disposed at two different heights.

10. A reactor according to claim 9, characterized in that the two deflectors (81; 82) are in the form of channels extending in two different directions.

11. A reactor according to claim 2, characterized in that the injection line (73) is connected to a gas distributor (74) in order to distribute the oxychlorination gas over the section of the oxychlorination zone.

12. A reactor according to claim 11, characterized in that the distributor (74) is composed of a plurality of tubes comprising orifices (90), a hood (91) covering each of the tubes in order to prevent the grains of catalyst from coming into contact with said tubes.

13. A reactor according to claim 2, characterized in that the wall of the reactor comprises reducers (89) for reducing the horizontal section of the oxychlorination zone.

14. A process for the catalytic reforming of a hydrocarbon feed, which is performed in a reactor according to claim 1, comprising
a stream of grains of catalyst is introduced at the head of the oxychlorination zone;
a stream of calcining gas is introduced via the calcining gas introduction line;
a stream of oxychlorination gas is introduced via the oxychlorination gas injection line;
a stream of gas is evacuated from the head of the oxychlorination zone;
a stream of grains of catalyst is evacuated from the bottom of the calcining zone.

15. A process according to claim 14, in which the grains of catalyst comprise platinum deposited on a porous support, the stream of calcining gas comprises air or oxygen-depleted air and is at a temperature in the range 400° C. to 550° C., the stream of oxychlorination gas comprises a chlorinated compound and is at a temperature in the range 350° C. to 550° C.

16. A method for obtaining a reactor according to claim 2, in which an existing reactor is remodelled by inserting said deflector into the oxychlorination zone.

17. A reactor (1) for the continuous regeneration of grains of catalyst, containing a vessel (2) comprising a first zone (72) positioned above a second zone (75) provided with a line (76) for introducing a first gas, the reactor comprising a line (73) for injecting a second gas opening into the bottom of the first zone (72) and a gas evacuation line (74b) at the head of the first zone, characterized in that the first zone (72) comprises at least one deflector means (82) for deflecting the flow of grains of catalyst.

18. A reactor according to claim 2, characterized in that the injection line (73) is connected to a gas distribution means (74) in order to distribute the oxychlorination gas over the section of the oxychlorination zone.

19. A reactor according to claim 2, characterized in that the wall of the reactor comprises means (89) for reducing the horizontal section of the oxychlorination zone.
